(19) United States
(12) Patent Application Publication
(10) Pub. No.: US 2015/0013826 A1
(43) Pub. Date: Jan. 15, 2015

(54) Filling Device

(71) Applicant: Walter Söhner GmbH & Co. KG Präzisionskunststofftiele, Schwaigern (DE)

(72) Inventor: Michael Driftmeyer, Schwaigern (DE)

(21) Appl. No.: 14/381,959

(22) PCT Filed: Feb. 28, 2013
(86) PCT No.: PCT/EP2013/054073

§ 371 Date: Aug. 28, 2014

(30) Foreign Application Priority Data
Feb. 28, 2012 (DE) 10 2012 003 702.3
Feb. 28, 2013 (WO) PCTEP2013054073

(51) Int. Cl. B67D 7/46; B67D 7/02

(52) U.S. Cl. CPC B67D 7/46; B67D 7/02
USPC 141/1; 141/198

(57) ABSTRACT

The invention relates to a device for filling a tank with a liquid medium, in particular a urea solution, comprising a filling pipe and comprising a suction channel for removing air from the tank. The invention is characterized in that at least one air guiding element is provided inside the suction channel, said air guiding element being designed to deflect the air transversely to the longitudinal axis of the filling pipe.

### BACKGROUND OF THE INVENTION

1. Field of the Invention

The present invention relates to a device for filling a tank with a liquid medium, in particular a urea solution, comprising a filling pipe and a suction channel for removing gas or respectively air from the tank. Furthermore, the invention relates to a device for filling a tank with a liquid medium, in particular a urea solution, with a filling pipe and a check valve element, which is attached to the end of the filling pipe. Finally, the invention relates to a filling system for a liquid medium, in particular a urea solution, with a device according to the invention for filling a tank with a liquid medium and a holding device for receiving the device for filling.

2. Description of Related Art

Aqueous urea solutions (for example, known under the brand name “AdBlue”) are increasingly being used for exhaust gas treatment for commercial vehicles, in particular trucks and omnibuses. Urea solutions are also now being increasingly used in passenger vehicles, wherein the urea solutions are stored in auxiliary tanks in the vehicle. The filling either takes place via commercially available canisters or—like fuel—at specially provided urea pumps. The delivery of urea solutions via special pumps will increase greatly in the future since this is more environmentally sound and cost-effective. Due to the chemical properties of urea solutions, tank systems must meet special requirements so that the filling systems known from the fuel field cannot be readily used.

This is due in particular to the fact that urea solutions crystallize and the crystals can lead to malfunctions. For this reason, the tank systems should be designed so that urea solutions cannot get to areas outside the filling pipe. Moreover, the filling should be able to take place easily and quickly.

### BRIEF SUMMARY OF THE INVENTION

Thus, the object of the present invention is, among other things, to design the initially named device for filling a tank with a urea solution such that contamination of the device and the vehicle is avoided.

This object is solved in the case of the device for filling a tank with a urea solution in that at least one air guiding element is provided inside the suction channel, said air guiding element being designed to deflect the air transversely to the longitudinal axis of the filling pipe.

In the previous solutions, the air (gas) suctioned out of the tank is normally suctioned more or less parallel to the filling pipe so that liquid components of the urea solution contained in the suctioned air can get into the entire suction channel area. Since the cleaning of areas of the suction channel that lie remote from the suction opening is more difficult, urea crystals can form there, which can lead to malfunctions.

Due to the fact that, in the case of the device according to the invention, the air flows transversely to the longitudinal axis of the filling pipe, i.e. either at a right angle or diagonal to the longitudinal axis, the flow path of the suctioned air is first extended so that liquid components rather remain in an area close to the suction opening. Since these front areas are easier to clean, the risk of malfunctions due to urea crystals can be reduced.

Preferably, the suction channel is delimited to the inside by the filling pipe and to the outside by a wall element surrounding the filling pipe at least partially. If the air guiding element is designed so that it extends around the filling pipe in a coil-like manner, the suctioned air is added to a circular or respectively coil-like path with the result that the liquid components are precipitated on the outer-lying wall element due to centrifugal force. In this manner, a large portion of the liquid components of the suctioned air can already be precipitated in the front area of the device for filling (hereinafter referred to as filling device). On one hand, these precipitated components can simply flow back into the tank or respectively out of the filling device so that their crystallization inside the filling device is avoided. On the other hand, these precipitations in the front area of the filling device can be easily removed through cleaning

In a preferred further embodiment, the wall element is designed as a bushing, which extends at least over the length of the at least one air guiding element. The air guiding element is preferably provided on a support element on its side facing the filling pipe, wherein the support element has a passage for the filling pipe. The air guiding element and the support element are also preferably designed from a single piece of material resistant to the liquid medium, preferably stainless steel or a plastic material.

These measures have proven to be particularly advantageous with respect to production. The support element can be easily pushed over the filling pipe and supports the air guiding element extending outward radially and progressing in a coil-like manner. The wall element delimiting the suction channel to the outside is designed as a tubular bushing, which in turn can be very easily pushed over the filling pipe and the support element with the air guiding element.

Thus, not only are the production costs of the individual parts low, but also the measures required for assembly. Furthermore, these components can also be replaced easily.

In a preferred further embodiment, the air guiding element has first sections that run at a right angle to the longitudinal axis of the filling pipe. It is furthermore preferred if the air guiding element has second sections, which run diagonally to the longitudinal axis of the filling pipe, wherein first and second sections alternate and two first sections are interconnected via a second section. It is furthermore preferred if two subsequent first sections are offset in the longitudinal direction and are arranged offset in the circumferential direction of the filling pipe by 180°.

This embodiment of the air guiding element delivers, on one hand, the coil-like flow path of the suctioned air and enables, on the other hand, a very beneficial production with little tool-based effort compared to a “real” coil-like progression.

In a preferred further embodiment, a check valve element is provided on the outlet end of the filling pipe.

The purpose of this check valve element is to seal the outlet end of the filling pipe if the urea solution is not delivered to the tank with a specified pressure. Since the check valve element is attached to the outlet end of the filling pipe, there is no or respectively minimal dripping of the urea solution after removing the filling device from the tank.

In a preferred further embodiment, the check valve element has a tubular housing with a first and a second longitudinal section, wherein the first longitudinal section has a smaller inner diameter than the second longitudinal section and has a conical diffusor, which is provided inside the second longitudinal section coaxially to it and faces the first longitudinal section with its diameter-larger end, wherein the diffusor supports a sphere in a spring-loaded manner such that the sphere can close and release the end of the first longitudinal section. Particularly preferably, the tubular housing has a third longitudinal section, which has a tapering inner diameter for forming a nozzle.

These measures ensure that the urea solution exits the outlet end in the most laminar manner possible. This laminar flow is achieved despite the fact that the urea solution must flow around the provided sphere of the check valve on the end of the filling pipe. The improvement in the flow is achieved through the conical diffusor, which ensures an expanding annular space between the tubular housing and diffusor, as seen in the longitudinal direction.

A laminar flow prevents foam or droplet formation and a backup in the area of the outlet end so that, as a result, the “danger” of an early and undesired shutdown is reduced.

The flow can be preferably further improved in that a aerator (e.g. in the form of a mixing jet) is provided on the outlet end, i.e. as seen in the direction of flow, after the check valve.

A spill-over and/or a spraying back of the liquid medium (so-called “spitback”) can thus be prevented.

Particularly preferably, the filling device is designed as a pump nozzle.

The handling and operating of the filling device is thus considerably simplified.

The object underlying the invention is also solved by a device for filling a tank with a liquid medium, in particular a urea solution, which has a filling pipe and the previously explained check valve element.

In other words, this means that the two characteristics of the suction channel with air guiding element and the check valve element can be used alone or in combination in a device for filling a tank in order to solve the object according to the invention. This also means that the preferred further embodiments described above can be used for both variants.

The object underlying the invention is also solved by a filling system for a liquid medium, in particular a urea solution, which has a filling device according to the invention for receiving the device for filling and a cleaning device, which is designed to clean the suction channel.

The cleaning device preferably generates an air flow for the cleaning

Particularly preferably, the cleaning device is connected with the end of the suction channel opposite the suction opening, wherein the cleaning device blows air into the suction channel, which flows through the suction channel to the suction opening. Naturally, the cleaning device can also suction air through the suction channel, for example up to the suction opening, in order to effectuate a cleaning.

Through the cleaning, liquid components present in the suction channel are blown and/or suctioned to the outlet end.

It is understood that the characteristics mentioned above and still to be explained below can be used not only in the respectively specified combination but also in other combinations or alone, without leaving the framework of the present invention.

### BRIEF DESCRIPTION OF THE SEVERAL VIEWS OF THE DRAWINGS

Additional advantages and embodiments of the invention result from the description and the accompanying drawings. The drawings show in:

FIG. 1 a perspective representation of a filling device according to the invention;

FIG. 2a, b a cross-sectional view of the filling device as well as an enlarged section from this view;

FIG. 3 an exploded view of the filling device according to the invention with a few removed structural elements;

FIG. 4 an exploded view of the filling device from the other side with a few removed structural elements;

FIG. 5a, b a sectional representation of a check valve element according to the invention in cross-section as well as in an exploded representation;

FIG. 6a, b a cross-sectional view of an alternative check valve element as well as an exploded representation of this check valve element;

FIG. 7 a schematic representation of a filling system according to the invention and

FIG. 8 a characteristic line of the delivery rate over time to explain the control behavior.

### DETAILED DESCRIPTION OF THE INVENTION

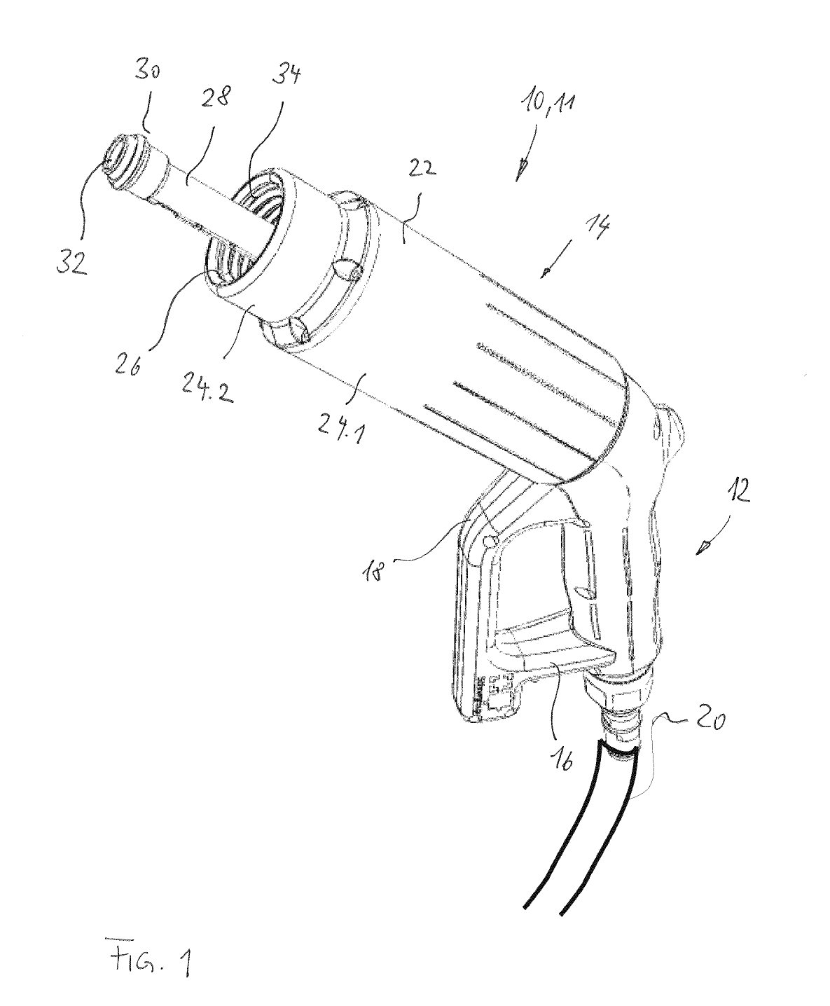

FIG. 1 shows a perspective view of a filling device with reference number 10. This filling device is preferably designed in the form of a pump nozzle 11. The filling device 10 serves to fill a vehicle, for example a passenger vehicle or a truck, with a liquid medium, in particular a urea solution (also known as “AdBlue”). The filling device is thereby designed to enable a closed filling. Such urea solutions are now very frequently used in the field of exhaust gas treatment, in particular to convert the nitrogen oxides into nitrogen and water vapor. Hereinafter, only a urea solution is mentioned as the liquid medium, although the described embodiments can also be used advantageously for other liquid mediums.

The filling device 10 has a handle area 12 and a connection area 14 connecting to it.

The handle area 12, which is preferably composed of two handle shells 16, 18 made of plastic, is with respect to its shape similar to the conventional shape of a pump nozzle of a tank system for gas, diesel, etc. On its end of the handle area 12 lying opposite the connection area 14, a medium hose 20 is connected or can respectively be connected, which feeds a urea solution on one hand and removes gas or respectively air (hereinafter, only “air” is referenced for simplification reasons) from the tank during filling on the other hand.

A cylindrical operating element 22, which is held in a rotatable manner around its longitudinal axis, is provided in the connection area 14. The operating element 22 serves to screw the filling device 10 with a connection piece (not shown) to a vehicle tank in order to enable a closed filling.

The operating element 22 has two longitudinal sections with different diameters, wherein the longitudinal section 24.1 that can be handled by the user has a greater diameter than the second longitudinal section 24.2 connected to it. The two longitudinal sections 24.1 and 24.2 of the operating element 22 are preferably provided from two separate components, which are interconnected for example via screws.

FIG. 1 shows an internal-thread element 26, which is provided coaxially to the second longitudinal section 24.2. This internal-thread element fits on the connection piece of a tank of a vehicle.

The connection between the internal-thread element 26 and the operating element 22, here in particular the second longitudinal section 24.2, is preferably not permanent, but rather provided in the form of a ratchet connection. This means that the operating element 14 during connection with the tank fitting continues to turn the internal-thread element until a specific torque is reached. The connection between the internal-thread element and the operating element 14 is then released so that the latter “turns”, without exerting further torque on the internal-thread element. The more exact structure of this ratchet connection will be explained later.

Finally, FIG. 1 also shows a filling pipe 28, which preferably extends coaxially to the operating element 14 and from the second longitudinal section 24.2. Instead of a coaxial arrangement, both elements could e.g. also be arranged eccentrically to each other. A check valve element 30 is provided on the end of the filling pipe 28, wherein the check valve element 30 has an outlet opening 32 for the urea solution. The outlet opening 32 is thus located at a predetermined distance from the internal-thread element 26 so that the filling pipe 28 protrudes into it during connection with the connection piece of a vehicle. Furthermore, a aerator is provided downstream from the check valve element 30 on the outlet opening 32, which upgrades or respectively conditions the outflow.

As already mentioned, air is removed from the tank during filling with the urea solution. During filling, the air thereby escapes and/or is suctioned away in a pendulum process. This removal of air takes place through an annular space 34, which is formed between the internal-thread element 26 and the filling pipe 28 or respectively occurs in the screwed-on state between the inner surface of the connection piece and the outside of the filling pipe 28. The filling pipe 28 itself serves solely to guide the urea solution.

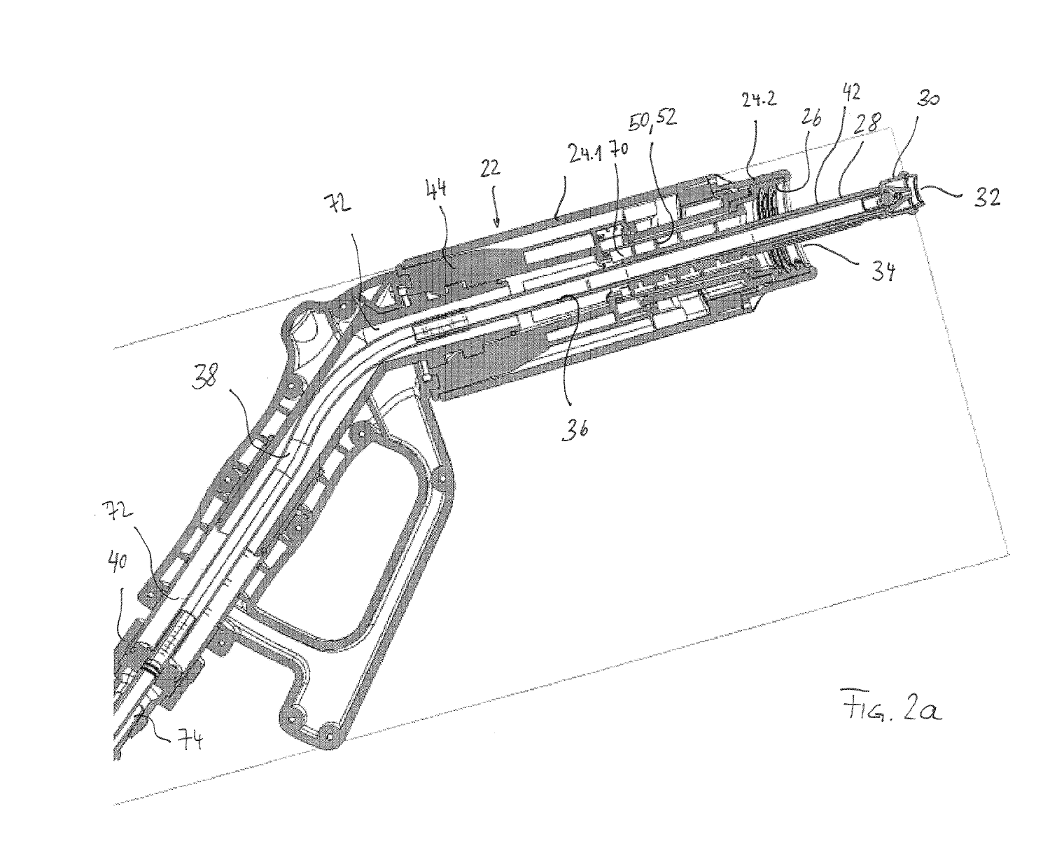

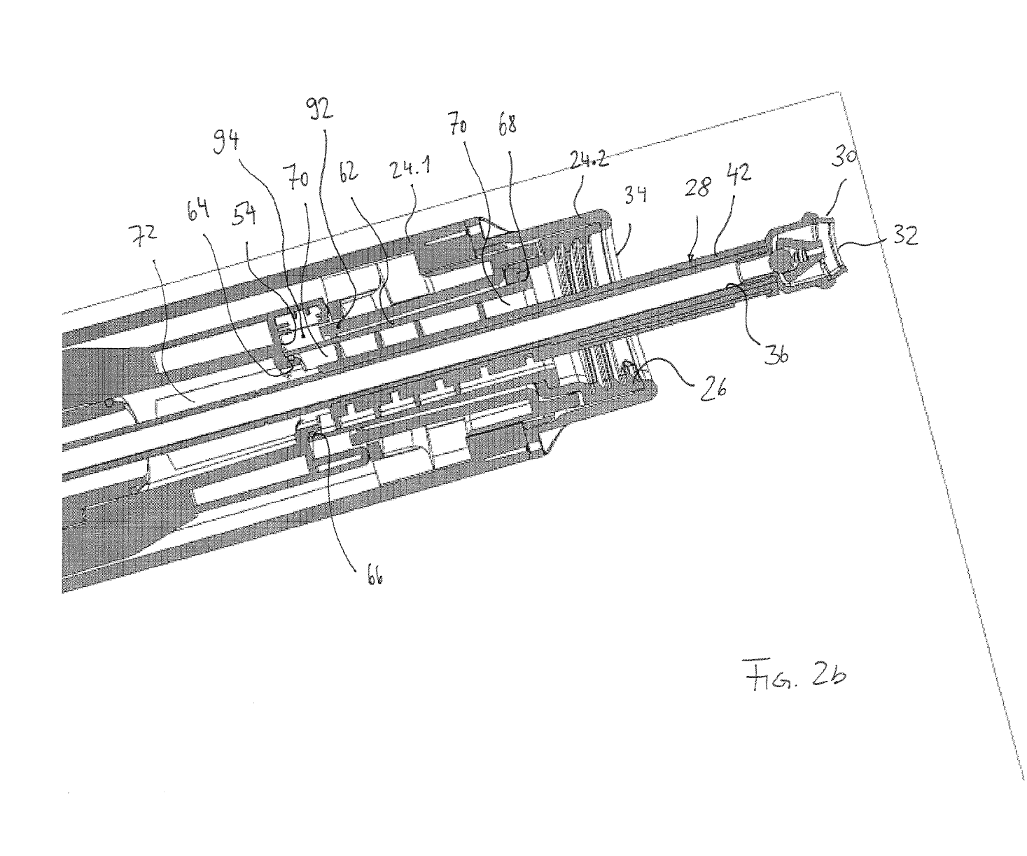

The inner structure of the filling device 10 is explained in detail below with respect to FIGS. 2 to 4.

The filling pipe 28 is formed at least in the area of the operating element 22 up to the outlet opening 32 as pipe 36, preferably made of stainless steel. This pipe 36 is connected with a hose 38 on its end lying opposite the outlet end 32, which extends through the handle area 12 up to a coupling element 40 on the end of the handle area 12. This coupling 40 serves to connect the medium hose 20.

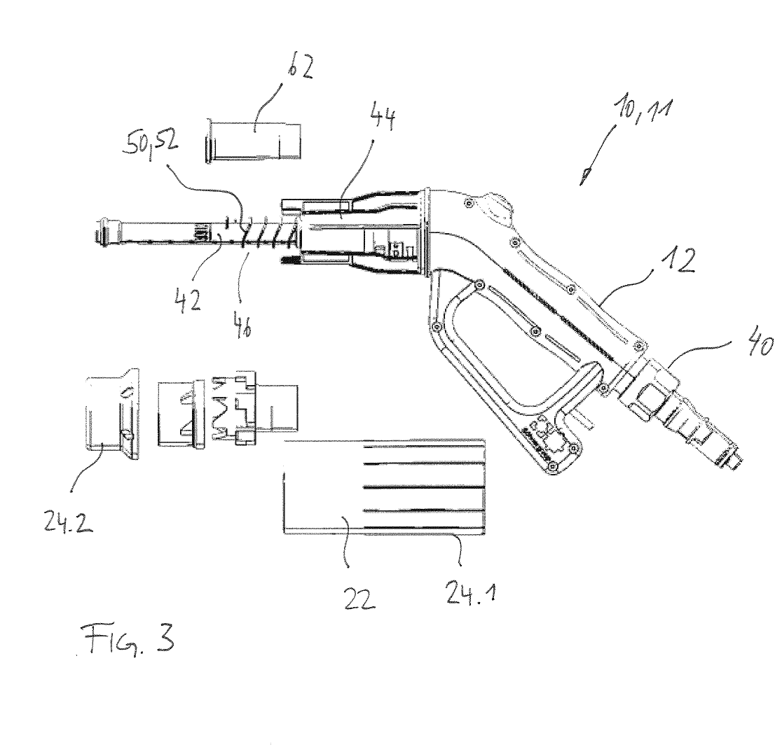

The pipe 36 is preferably guided coaxially (eccentrically would also be possible) within the operating element 22 and is surrounded by a bushing 42 in its front longitudinal section, i.e. facing the outlet end 32, wherein this bushing 42 is part of a housing element 44. The bushing 42 and the housing 44 are easy to see in FIG. 3. The bushing 42 is designed so that the inside of the bushing 42 rests on the pipe 36. The inner diameter of the bushing 42 thus corresponds approximately with the outer diameter of the pipe 36. The pipe 36 is preferably coated for insulation.

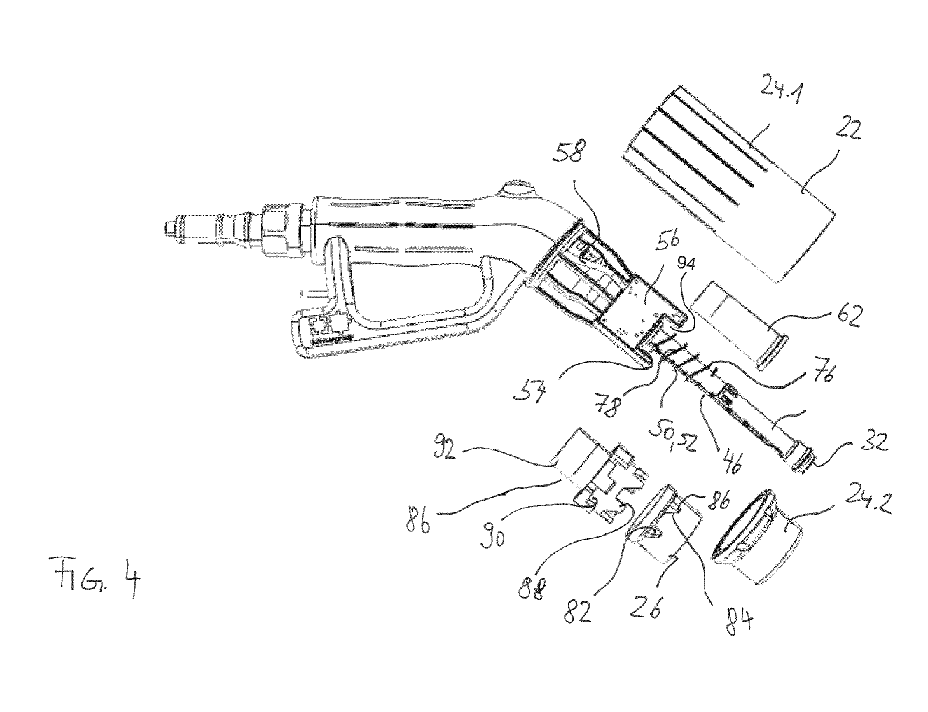

As can be seen in particular from FIGS. 3 and 4, the bushing has a preferably coil-like structure 50, which serves as an air guiding element 52, in a longitudinal section 46.

The housing 44 has a larger diameter than the bushing 42 so that a step 54 is formed. The surface of this step 54 extends diagonally, in particular at a right angle, to the longitudinal axis of the filling pipe 28. The housing 44 serves, among other things, to receive a printed circuit board 56 and corresponding connection lines 58. The printed circuit board 56 carries all electronic components required to operate the filling device, which provide in particular a sealing identification and a fill level identification and forward the corresponding signals to the filling system.

A stop bushing 62, the inner diameter of which corresponds with the outer diameter of the coil-like structure 50, is mounted on the longitudinal section 46 of the bushing 42. In particular, the stop bushing 62 is designed such that the coil-like structure 50 rests on the inside of the stop bushing 62. The stop bushing 62 is stuck above a tubular fitting 64 in the area of the step 54, wherein an O-ring 66 seals the connection, in particular from the passage of air or the urea solution.

The stop bushing 62 has a flange 68 on its end facing the outlet end 32, which is engaged behind by an annular end section of the internal-thread element 26.

The bushing 42 with the coil-like structure 50 forms an air guiding channel 70 together with the stop bushing 62 and the internal-thread element 26, which extends up to the step 54 and the fitting 64. From there, the channel 70 opens into an annular space 72, which extends up to the coupling 40 on the end of the handle area 12. There, the annular space 72 opens into a corresponding air guiding channel 74.

The coil-like structure 50 serves as an air guiding element 52 and ensures that the air from the tank does not flow straight to the step 54 and into the annular space 72, but rather is directed in a coiled path around the filling pipe 28 and the bushing 42. This—in the projection—circular movement of the air in the longitudinal section 46 ensures that liquid components in the suctioned air wander to the outside through the centrifugal forces and precipitate to the greatest extent possible on the stop bushing 62. Furthermore, the air guiding channel is lengthened substantially. The geometry of this coil-like structure 50 as well as the arrangement of the transition between the air guiding channel 70 and the annular space 72 should be designed so that liquid components are precipitated before transfer of the air into the annular space 72. These liquid components can then again run along the bushing 42 or respectively the stop bushing 62 in the direction of the outlet end 32.

This cyclone-like guidance of the suctioned air flow should prevent the liquid components, i.e. urea solution, from getting into areas downstream of the step 54. The considerably extended air guidance and the coil-like or respectively labyrinth-like arrangement of the air guiding element also contribute to this. Blockages/malfunctions that are not easy to fix result from the crystallization of this urea solution in this area. A cleaning of just the front longitudinal section 46 of the bushing 42 is also much easier from the outside. Moreover, this part can also be replaced easily.

For production reasons, the structure 50 is not designed exactly in a coil-like manner. Rather, this structure is composed of straight sections 76 and 78, wherein the sections 76 run at a right angle to the longitudinal axis of the bushing 42 and the sections 78 diagonal to the longitudinal axis. As results from FIG. 3 or respectively 4, right-angle sections 76 and diagonal sections 78 alternate so that a diagonal section 78 connects two right-angle sections 76 offset in the longitudinal direction and offset in the circumferential direction by 180°. All longitudinal sections 76, 78 are preferably interconnected so that the coil-like structure results.

As already mentioned, this coil-like structure ensures that the flow channel is elongated and the coil prevents the urea solution directly flowing or sloshing back from getting directly inside the pump nozzle. Furthermore, the escaping air flows around the bushing 42 in a coil-like manner so that liquid components in the suctioned air precipitate on the outer-lying stop bushing 62 due to centrifugal force. One advantage of this coil-like structure is that the flow path from the internal-thread element 26 to the step 54 is extended considerably so that urea solution rising or respectively sloshing back in the tank does not so quickly reach the annular space 72 lying behind the step 54.

As results from FIGS. 3 and 4, the internal-thread element 26 preferably has serrated recesses 82 on its border area facing away from the outlet end, the diagonally progressing flanks 84 of which—in the case of a clockwise revolution—lie in front and the perpendicular flank 86 behind. If a counter-clockwise revolution is desired, the diagonally and perpendicularly progressing flanks are arranged accordingly in the opposite manner.

In the case of the turning of the operating element 22, the internal-thread element 26 works together with a trigger element 86, which has correspondingly designed saw teeth 88 on its end facing the internal-thread element 26. The arrangement of these saw teeth 88 in the circumferential direction of the cylindrical trigger element 86 corresponds to the arrangement of the recesses 82 so that the saw teeth 88 can dip into the recesses 82.

The trigger element 86 has driving elements 90 on its circumferential surface, which work together with corresponding elements on the inside of the first longitudinal section 24.1 of the operating element 22. A rotational movement of the operating element 22 is transferred to the trigger element 86 via these driving elements 90. This rotational movement is transferred to the internal-thread element 26 via the diagonal flanks of the saw teeth 88 so that the internal-thread element 26 can be screwed onto the external thread of the connection piece of the tank on the vehicle. As soon as the internal-thread element 86 is tightened, the diagonal flanks of the saw teeth 88 of the trigger element 86 glide along the diagonal flanks 84 of the recesses 82 so that the entire trigger element 86 moves backwards in the longitudinal direction, i.e. away from the outlet end 32. As soon as the saw teeth 88 have left the recesses 82, the operating element 22 can be turned clockwise.

In order to release the internal-thread element 26 from the connection piece again, the operating element can be turned counter-clockwise, wherein the perpendicular flanks of the saw teeth 88 then work together with the perpendicular flanks 86 of the recesses 82 in a form-fitting manner and can transfer the torque for the opening.

The trigger element 86 has a cylindrical section 92, which—as can be seen in FIG. 2b —dips into an area 94 while it is gliding back. This area is monitored electrically/electronically, for example with the help of optical/opto-electrical elements in order to deliver a signal to the control electronics, which signals a complete sealing or respectively screwing on of the filling device. Naturally, the dipping of the cylindrical section 92 into the area 94 can be detected and captured not just optically, but for example also mechanically via mechanical switch elements. For example, magnetoresistive switches, Reed switches, Hall sensors, etc. are conceivable as switch elements.

As results for example from FIG. 2b, the check valve element 30 is inserted, e.g. stuck or screwed, into the end of the filling pipe 28. This check valve element serves to prevent the running of the urea solution out of the filling pipe as soon as the urea solution is no longer pumped. In other words, this means that this valve is only opened when a certain pressure is reached in the filling pipe 28.

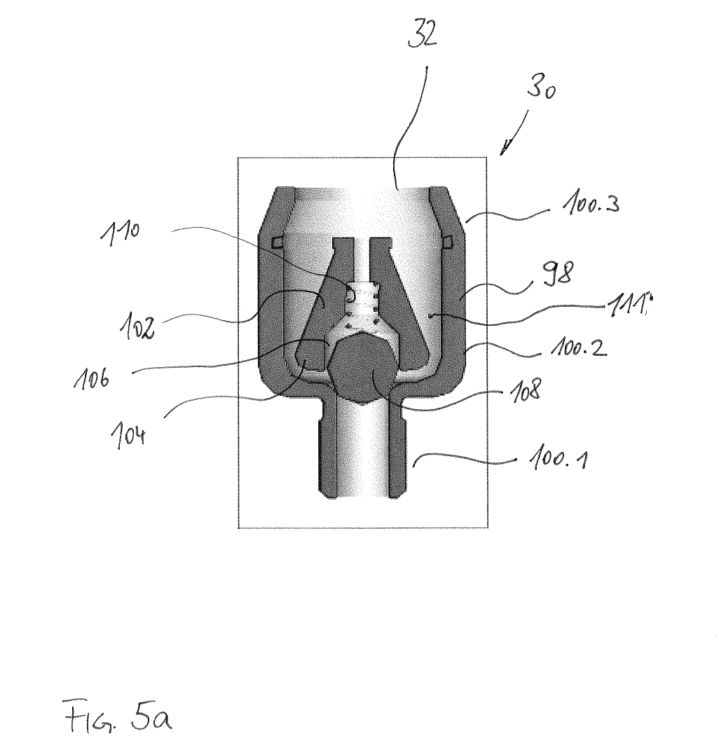

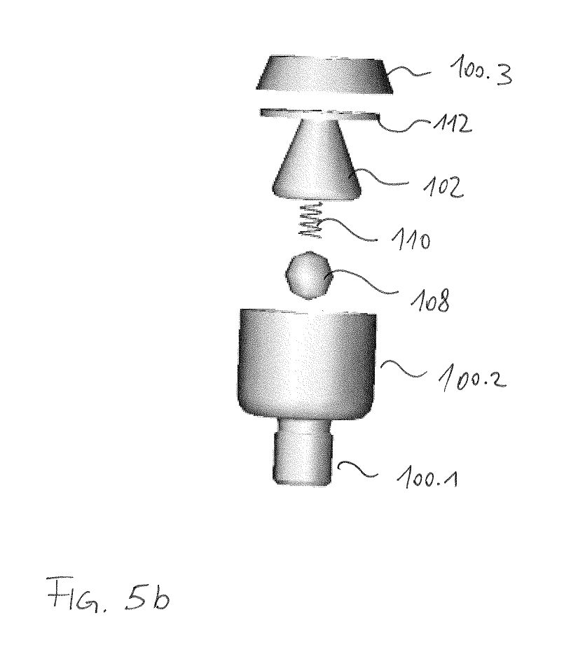

The structure of the check valve element 30 according to a first embodiment is shown in FIGS. 5a and 5b. The check valve element 30 has a cylindrical housing 98, which has a first longitudinal section 100.1 preferably with thread, a second longitudinal section 100.2 connecting to it and a third longitudinal section 100.3 connecting to it. The first longitudinal section 100.1 is designed so that it can be stuck or screwed into the filling pipe 28, in particular into the inner-lying pipe 36. The outer diameter of this first longitudinal section 100.1 thus corresponds with the inner diameter of the pipe 36. The second longitudinal section 100.2 now has a greater outer diameter than the first longitudinal section and a greater inner diameter than the first longitudinal section 100.1.

The third longitudinal section 100.3 has a tapering outer diameter as well as a tapering inner diameter, wherein it should be noted here that the outer diameter of the second and of the third longitudinal section 102, 103 can also be designed differently than shown. These two longitudinal sections depend solely on the design of the inner diameter.

Within the second longitudinal section 100.2, a diffusor element 102 is provided, which has a conical or respectively cone-shaped outer geometry. The larger (with respect to the diameter) end 104 of the diffusor thereby faces the first longitudinal section 100.1.

The diffusor element 102 is attached to the inside of the housing 98 via fastening elements 112, wherein this fastening should cover as little flow cross-section as possible.

The diffusor element 102 has on its end 104 a recess 106, which serves to receive a sphere 108 and a spring 110. One side of the spring 110 is supported on the diffusor element 102 and the other side on the sphere 108. The spring presses the sphere 108 against the opening of the longitudinal section 101 in order to seal this opening. In order to release the opening, i.e. to press the sphere into the diffusor element 102 against the force of the spring 110, the urea solution must be conveyed with a certain pressure.

If the sphere 108 has released the opening, the urea solution can flow into the annular space 112 around the end 104 of the diffusor element 102. Due to the conical shape of the diffusor element 102, the annular space 112 expands in the direction of flow, i.e. towards the outlet end 32. The flow channel cross-section thus increases.

The purpose of this geometry is to even out, i.e. to make laminar, the flow after the flowing around of the end 104 of the diffusor element. The pressure and the flow speed decrease in this area. The tapering longitudinal section 100.3, which works like a nozzle, also further contributes to a laminar flow.

It has been shown that the combination of an increasing annular area 112 in the longitudinal section 102 and a decreasing cross-sectional area in the subsequent longitudinal section 100.3 delivers a very good laminar flow of the urea solution even though the check valve is located in the flow path in this area.

The structure of the check valve element 30 is shown again in FIG. 5b in the form of an exploded representation. The fastening element 112 attached to the diffusor element 102, which is designed as a ring, can be seen in this figure, wherein few spokes run to the diffusor element and are attached there. The ring of the fastening element 112 is carried by the second longitudinal section 102.

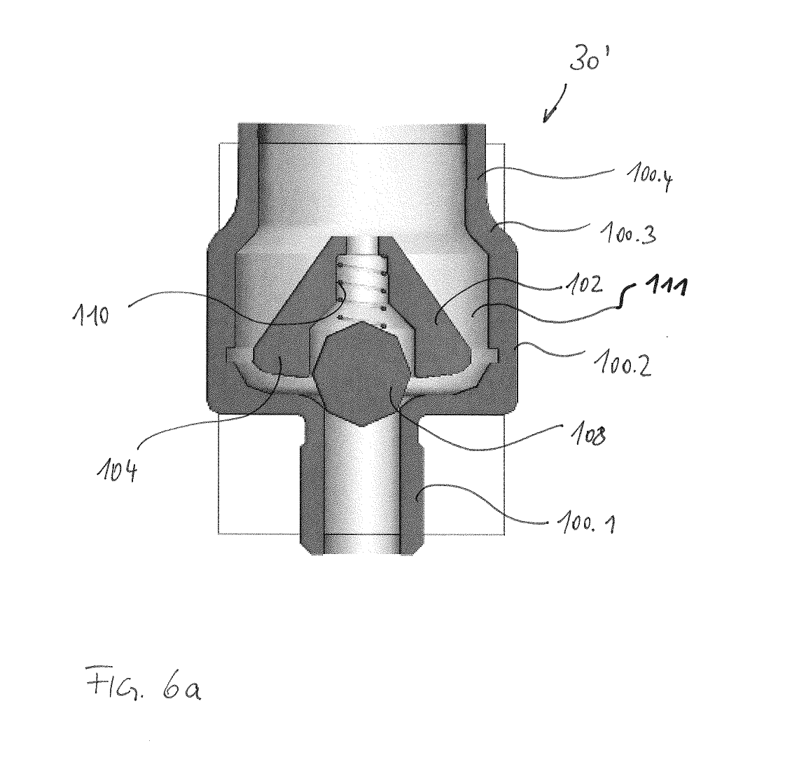

An alternative embodiment of a check valve element 30′ is shown in FIGS. 6a and 6b, wherein functionally identical parts are labelled with the same reference numbers.

One of the main differences in this embodiment is that an additional cylindrical longitudinal section 100.4 is connected to the nozzle-like, third longitudinal section 100.3, the inner diameter of which is the same in the longitudinal direction. Moreover, fastening elements 112′ are provided on the end 104 of the diffusor element 102, which are supported by the second longitudinal section 100.2.

The functionality of this alternative embodiment of the check valve element 30′ is the same as that of the previously described check valve element 30 so that it can be referenced.

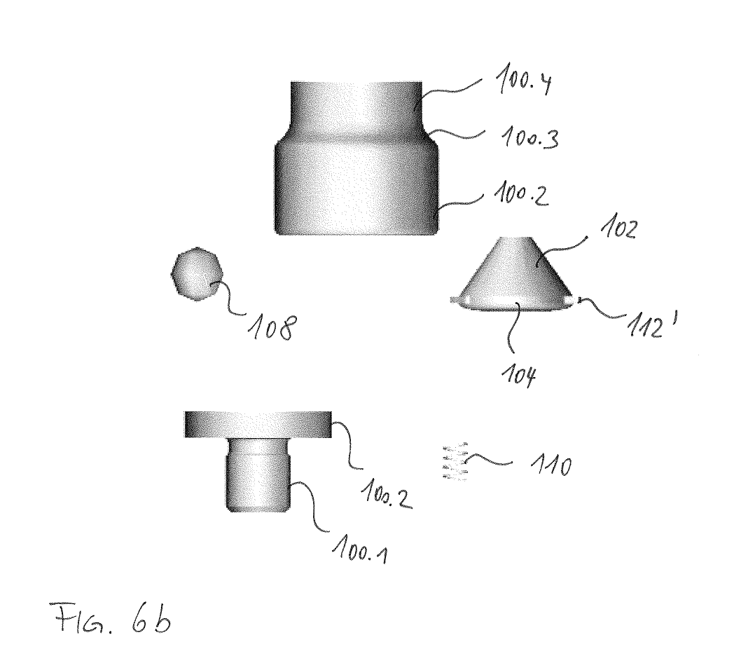

FIG. 7 shows a schematic representation of a tank system labelled with reference number 114. The tank system 114 comprises a tank pump 115, which has a receiving shaft 116 for the pump nozzle 11, which is shown here as a triangle for simplification reasons. The pump nozzle 11 is connected with the tank pump 115 via a hose 117, wherein the hose 117 has an inner line 107 for the urea solution and an outer air or respectively gas return line preferably provided as a ring line. Moreover, electrical lines progress in the hose 117 in order to supply power to the controller in the pump nozzle on one hand and to return signals to a controller provided in the tank pump 115 on the other hand. A fast switching valve 118, in particular a magnetic valve, is assigned to the line 117, which can open and close the connection into the urea line 107 in the hose 117 within a few milliseconds. Moreover, a pressure sensor 119 is assigned to the inner line 107, which is preferably provided in the area of the pump nozzle 11.

Furthermore, the tank pump 115 comprises a cleaning device 120, which is provided to clean the pump nozzle 11 as well as the line for removing the air.

To clean the pump nozzle 11, air, which is fed to the pump nozzle 11, either through the hose 117, e.g. the air return channel, is used in order to clean in particular the front area of the pump nozzle. For this, it can be provided for example that the pump nozzle lies in the receiving shaft 116 in order to be able to catch the blown out urea solution.

Alternatively, it is naturally also conceivable to blow the air from the cleaning device 120 to the receiving shaft 116 and there directly into the annular space 34 of the pump nozzle 11. Alternatively, a cleaning can also be performed via a suctioning of air out of the annular space 34 of the pump nozzle.

As already mentioned, the pump nozzle 11 is screwed onto the connection piece of the vehicle for filling until the operating element 22 slips. The electronics provided inside the pump nozzle 11 captures the movement of the cylindrical section 92 into the area 94 and returns a signal to the tank pump 115. The controller provided there now detects that the pump nozzle is turned completely onto the connection piece and then releases the filling. The user then presses for example a filling button on the tank pump 115, wherein the filling process is started. For this, the valve 118 is first released and the delivery pump can then deliver urea solution through the hose 117 and the pump nozzle 11 to the tank, wherein the pressure sensor 119 delivers control signals for regulation to the controller. The delivery rate specified by the controller is thereby set to a first value. A sensor attached to the end of the filling pipe 28, for example in the form of two electrodes, detects the fill level inside the connection piece of the vehicle. The two electrodes required for this are provided either as separate components or the filling pipe 28 preferably serves e.g. as one of the two electrodes. As soon as the sensor is moistened by the urea solution, a corresponding fill signal is transmitted to the controller in the tank pump. In response to this signal, the controller stops the delivery pump and closes the valve 118.

If the fill signal now changes within a specifiable period of time, for example three seconds, the delivery of urea solution continues. Only when urea solution permanently, i.e. longer than the specified period of time, moistens the sensor on the filling pipe 28 is the filling completed. The controller in the tank pump 115 registers this event and prevents further filling of the vehicle.

Since the sensor for capturing the fill level lies very close to the end of the filling piece of the vehicle, it must be prevented that even small amounts of urea solution spill out of the delivery pump after the stoppage. This is achieved with the valve 118 (e.g. a 3/2-way valve or a pure stop valve), which closes the line for the urea solution within a few milliseconds so that the residual amount still delivered due to the inertia of the delivery pump no longer makes its way to the hose 117. In the case of the use of a 3/2-way valve as the valve, the residual amount is fed back to a storage tank from which the urea solution is delivered.

It should be noted here that the valve 118 can naturally also be provided in the pump nozzle 11.

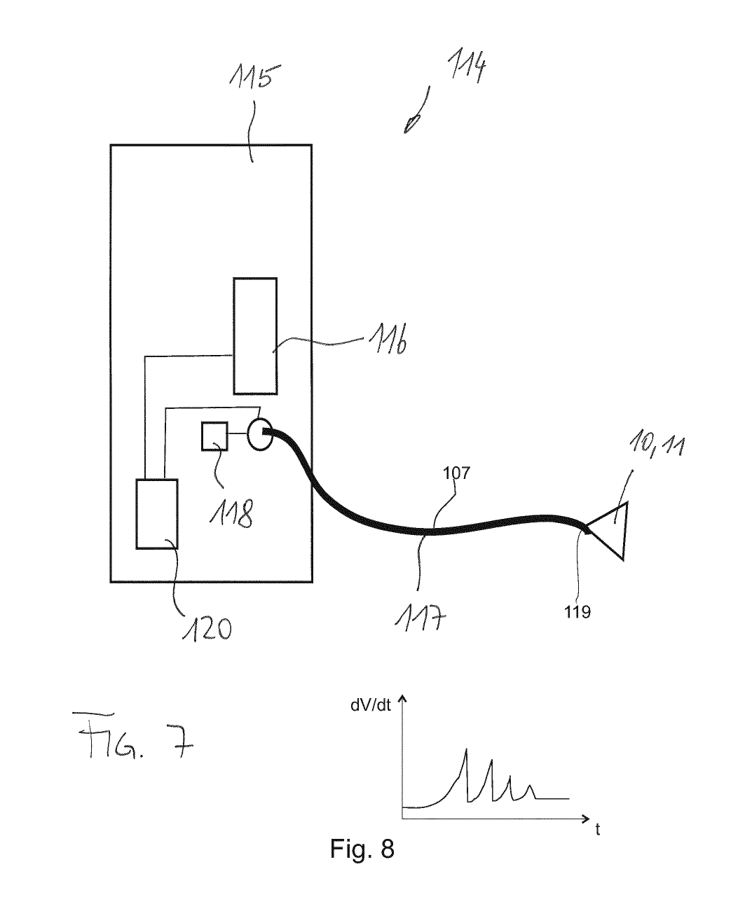

As already mentioned and shown in FIG. 8, the filling is performed with a first adjustable delivery rate dV/dt. After receipt of a first fill signal, filling now preferably continues with a second delivery rate, which is also adjustable and is less than the first delivery rate. In other words, this means that the filling first takes place at a higher delivery rate until the sensor delivers a fill signal. If this fill signal disappears after the specified period of time, it continues to be delivered, but then with the second delivery rate, which is lower. If the controller in the tank pump then receives another fill signal, it is stopped in turn and delivered again after the specified period of time as long as the fill signal has disappeared. The delivery rate can then be the same as the second delivery rate or can alternatively be further reduced.

The filling with such a two-stage or multi-stage delivery rate makes it possible to fill the tank quickly on one hand and with the maximum possible fill level on the other hand. Naturally, the delivery-rate profile shown in FIG. 8 is adjustable and changeable.

It is particularly preferred to not operate the delivery pump directly with the first delivery rate during startup, but rather to slowly increase the delivery pump to this delivery rate. The “startup curve” can thereby be specified in the controller. Alternatively, the “startup curve” is permanently specified.

When switching on the delivery pump again, this “startup curve” can be used again or, alternatively, delivery can proceed immediately with the second, lower delivery rate.

Finally, it should be noted that the ratchet connection described above, in particular with the electronic capturing of the dipping of the trigger element into the area 94, can also preferably be used without the other characteristics of the filling device.

Overall, it has been shown that a filling device as well as a tank system are provided, which have a plurality of advantages and can nevertheless be implemented in a cost-effective manner.

1.-23. (canceled)

24. A filling system for filling a liquid medium, in particular an urea solution, into a vehicle tank with
a filling device with a filling pipe and a fill level sensor on said filling pipe, wherein the fill level sensor emits a fill signal when the fill level sensor detects the liquid medium
a delivery pump for delivering the medium to the filling device, and
a control device, which is designed to switch off the delivery pump when a fill signal is received and to switch the delivery pump back on when the fill signal is no longer received after a specified period of time.

25. The filling system according to claim 24, wherein
said control device is designed to set the delivery pump to a lower delivery rate when switched back on.

26. The filling system according to claim 24, wherein
a switching valve is provided in a delivery conduct for the medium, and the control device is designed to close said switching valve when a fill signal is received.

27. The filling system according to claim 24, wherein
said control device is designed to increase a delivery rate of said delivery pump upon startup according to a startup curve.

28. The filling system according to claim 24, wherein
said control device is designed to control said delivery pump to stop operation every time a fill signal is received, and to operate with a specified delivery rate when said fill signal is no longer received after a specified period of time, said specified delivery rate changing according to a delivery rate profile.

29. The filling system according to claim 28, wherein
said delivery rate profile is adjustable.

30. The filling system according to claim 24, wherein
a pressure sensor is arranged to sense the pressure within a delivery conduct for said medium.

31. The filling system according to claim 24, wherein
said filling device comprises a suction channel for removing air from the tank.

32. The filling system according to claim 31, wherein
said filling device comprises at least one air guiding element provided inside the suction channel, said air guiding element being designed to deflect air transversally to the longitudinal axis of the filling pipe.

33. The filling system according to claim 31, wherein
the suction channel is formed between the filling pipe and a wall element surrounding the filling pipe at least in sections.

34. The filling system according to claim 32, wherein
the air guiding element progresses in a coil-like or labyrinth-like manner around the filling pipe.

35. The filling system according to claim 33, wherein
the wall element is designed as a bushing and extends at least over the length of the at least one air guiding element.

36. The filling system according to claim 32, wherein
the air guiding element and a support element are made from a single piece of a material that is resistant with respect to the liquid medium.

37. The filling system according claim 32, wherein
the air guiding element has first sections arranged under a right angle to the longitudinal axis of the filling pipe, and second sections arranged diagonally to the longitudinal axis of the filling pipe, wherein said first and second sections alternate and two of said first sections are interconnected via a second section.

38. The filling system according to claim 37, wherein
two consecutive first sections are offset in the longitudinal direction and are arranged offset in the circumferential direction of the filling pipe by 180°.

39. The filling system according to claim 24, wherein
a check valve element is provided on the outlet end of the filling pipe.

40. The filling system according to claim 24, wherein
a aerator is provided on the outlet end of the filling pipe.

41. The filling system according to claim 39, wherein
said check valve element has a tubular housing with a first and a second longitudinal section, said first longitudinal section having a smaller inner diameter than said second longitudinal section,
said check valve element further comprising a conical diffuser provided coaxially inside said second longitudinal section and facing said first longitudinal section with its larger diameter end, wherein said diffuser supports a sphere in a spring-loaded manner arranged to close and release the end of the first longitudinal section.

42. The filling system according to claim 41, wherein
said tubular housing has a third longitudinal section, which has a tapering inner diameter for forming a nozzle.

43. The filling system according to claim 39 wherein
the check valve element is provided in a replaceable manner on the end of the filling pipe.

44. The filling system according to claim 24, wherein
said filling device is designed in the form of a pump nozzle.

45. The filling system according to claim 31, said filling system further comprising a cleaning device for cleaning said suction channel.

46. The filling system according to claim 45, wherein
said cleaning device is designed to clean at least the outlet end of the filling pipe and/or the check valve element.

47. The filling system according to claim 45, wherein
said cleaning device generates an air flow for cleaning.

48. The filling system according to claim 45, wherein
said cleaning device is connected to the end of the suction channel opposite the suction opening and blows air into the suction channel, said air flowing through the suction channel to the suction opening.

49. The filling system according to claim 45, wherein
said cleaning device is connected to the suction opening of the suction channel and suctions air out of the suction channel.

50. A method for filling a vehicle tank with a liquid medium, in particular an urea solution, comprising
connecting a filling device to said tank, said filling device comprising a filling pipe and a fill level sensor on the filling pipe for emitting a fill signal when the fill level sensor detects the liquid medium,
operating a delivery pump for delivering the medium to the filling device, deactivating said delivery pump when a fill signal is received, and
reactivating said delivery pump when the fill signal is no longer received after a specified period of time.

51. The method according to claim 50, wherein
when said delivery pump is first activated, said medium is delivered at a first delivery rate, and when reactivated, said medium is delivered at a second, lower delivery rate.

52. The method according to claim 50, further including closing a switching valve provided within a delivery conduct for said medium when a fill signal is received.

53. The method according to claim 50, further including increasing a delivery rate of said delivery pump upon startup according to a startup curve.

54. The method according to claim 50, further including controlling said delivery pump to stop operation every time a fill signal is received, and to operate with a specified delivery rate when said fill signal is no longer received after a specified period of time, said specified delivery rate changing according to a delivery rate profile.
